(19) United States
(12) Patent Application Publication
(10) Pub. No.: US 2015/0134578 A1
(43) Pub. Date: May 14, 2015

(54) DISCRIMINATOR, DISCRIMINATION PROGRAM, AND DISCRIMINATION METHOD

(71) Applicant: DENSO CORPORATION, Kariya-city (JP)

(72) Inventors: Yukimasa TAMATSU, Okazaki-shi (JP); Ikuro SATO, Yokohama (JP)

(21) Appl. No.: 14/540,295

(22) Filed: Nov. 13, 2014

(30) Foreign Application Priority Data
Nov. 14, 2013 (JP) 2013-235810

(51) Int. Cl. G06N 99/00; G06N 5/04

(52) U.S. Cl. CPC G06N 99/005; G06N 5/04
USPC 706/12

(57) ABSTRACT

A discriminator based on supervised learning includes a data expanding unit and a discriminating unit. The data expanding unit performs data expansion on unknown data which is an object to be discriminated in such a manner that a plurality of pieces of pseudo known data are generated. The discriminating unit applies the plurality of pieces of unknown pseudo data that has been expanded by the data expansion unit to a discriminative model so as to discriminate the plurality of pieces of pseudo unknown data, and integrates discriminative results of the plurality of pieces of pseudo unknown data to perform class classification such that the unknown data is classified into classes.

### CROSS-REFERENCE TO RELATED APPLICATION

This application is based on and claims the benefit of priority from Japanese Patent Application No. 2013-235810, filed Nov. 14, 2013, the disclosure of which is incorporated herein in its entirety by reference.

### BACKGROUND

1. Technical Field

The present invention relates to a discrimination apparatus, a discrimination program, and a discrimination method based on supervised learning. In particular, the present invention relates to a discrimination apparatus, a discrimination program, and a discrimination method that use a discriminative model generated through a learning process of training data that has been expanded.

2. Related Art

To construct a discriminator based on supervised learning, training data that accompanies target values is required to be collected. The relationships between input and output of the training data are then required to be learned within the framework of machine learning. The target value refers to the output of the training data. During a learning process, when a certain piece of training data is inputted, retrieval of learning parameters is performed so that the output from a discriminator becomes closer to the target value corresponding to the piece of training data.

A discriminator that is obtained through the learning process described above performs, during operation, discrimination of unknown data that is not included in the training data but is similar in pattern. Discriminative capability for the unknown data that is an object for such discrimination is referred to as generalization capability. The discriminator is required to have high generalization capability.

In general, as the amount of training data increases, the generalization capability of the discriminator trained using such training data increases. However, personnel cost is incurred when collecting training data. Therefore, it is demanded that high generalization capability be achieved with a small amount of training data. In other words, a measure against low distribution density of training data is required.

Here, a heuristic method referred to as data expansion has been proposed. Data expansion is described in P. Y. Simard, D. Steinkraus, J. C. Platt, “Best Practices for Convolutional Neural Networks Applied to Visual Document Analysis”, ICDAR 2003 (hereinafter referred to as P. Y. Simard et al.) and Ciresan, et al., “Deep Big Simple Neural Nets Excel on Handwritten Digit Recognition”, Neural Computation 2010 (hereinafter referred to as Ciresan, et al.). Data expansion refers to increasing the types of data by subjecting data provided as a sample to parametric deformation. However, these deformations must not compromise the unique features of the class to which the original data belongs.

In P. Y. Simard et al., research on handwritten digit recognition using a convolutional neural network (CNN) is described. Here, training data undergoes transformation referred to as “elastic distortion”. A large amount of data is artificially generated as a result (data expansion). The data that has been generated is then learned. It is described that, as a result of learning such as this, discriminative capability that is significantly higher that when data expansion is not performed can be achieved.

In addition, in Ciresan, et al., research on handwritten digit recognition using a neural network is described. Here, data expansion is performed by transformation of rotation and scale, in addition to elastic distortion. It is described that extremely high recognition capability can be achieved as a result.

In this way, in P. Y. Simard, et al. and Ciresan, et al., regarding the issue of handwritten digit recognition, deformations such as localized elastic distortions, minute rotations, and minute scale changes are applied. As a result, data expansion that does not compromise the features of the digits becomes possible. Generalization capability that is higher than that when data is not expanded can be successfully achieved. Performing discrimination of unknown data after learning through data expansion has been performed is commonly practiced in the field of image recognition in particular.

### SUMMARY

It is thus desired to improve a discriminative capability of a discriminator when a discrimination of unknown input data is performed based on a learning process using data expansion of training data.

A first exemplary embodiment of the present disclosure provides a discriminator based on supervised learning. The discriminator includes a data expanding unit and a discriminating unit. The data expanding unit performs data expansion on unknown data which is an object to be discriminated in such a manner that a plurality of pieces of pseudo unknown data are generated. The discriminating unit applies the expanded plurality of pieces of pseudo unknown data to a discriminative model so as to discriminate the expanded plurality of pieces of pseudo unknown data. The discriminating unit then integrates the discriminative results of the expanded plurality of pieces of pseudo unknown data to perform class classification such that the unknown data is classified into the classes.

In this configuration, the unknown data is expanded in such a manner that the plurality of pieces of pseudo unknown data are generated. The discrimination results of the plurality of pieces of pseudo unknown data are integrated, and then, the class classification of the unknown data is performed based on the integrated discrimination results. Therefore, discriminative capability is improved compared to when discrimination is performed on the unknown data itself.

In the exemplary embodiment, the data expanding unit may perform data expansion on the unknown data using the same method as the data expansion performed on training data when the discriminative model is generated. In this configuration, the unknown data is expanded by the same method as that for expansion of training data when the discriminative model is generated. Therefore, the probability that their distribution overlaps a posterior distribution of class increases. Discriminative capability is improved for when data expansion of the training data is performed when the discriminative model is generated.

In the exemplary embodiment, the discriminator may perform the class classification based on expected values derived by applying the plurality of pieces of pseudo unknown data to the discriminative model.

In this configuration, class classification is performed using, as a decision rule, minimization of an objective function (also called, e.g., an error function or a cost function) for when the discriminative model is generated. Therefore, discriminative capability is improved for when data expansion of the training data is performed when the discriminative model is generated.

In the exemplary embodiment, the discriminating unit may perform the class classification without applying the unknown data to the discriminative model. In this configuration, class classification of the unknown data is performed without the unknown data itself being used for discrimination.

In the exemplary embodiment, the data expanding unit may perform data expansion on the unknown data using random numbers. In this configuration, the unknown data is expanded using random numbers. Therefore, the probability that their distribution overlaps the posterior distribution of class increases. Discriminative capability is improved for when data expansion of the training data is performed when the discriminative model is generated.

A second exemplary embodiment of the present disclosure provides a computer-readable storage medium storing a discrimination program that enables a computer to function as a discriminator based on supervised learning. The discriminator includes a data expanding unit and a discriminating unit. The data expanding unit performs data expansion on unknown data which is an object to be discriminated in such a manner that a plurality of pieces of pseudo unknown data are generated. The discriminating unit applies the expanded plurality of pieces of pseudo unknown data to a discriminative model so as to discriminate the expanded plurality of pieces of pseudo unknown data. The discriminating unit then integrates the discriminative results of the expanded plurality of pieces of pseudo unknown data to perform class classification such that the unknown data is classified into classes.

In this configuration as well, the unknown data is expanded in such a manner that the plurality of pieces of pseudo unknown data are generated. The discrimination results of the pieces of pseudo unknown data are integrated. And then, class classification of the unknown data is performed based on the integrated discrimination results. Therefore, discriminative capability is improved compared to when discrimination is performed on the unknown data itself.

A third exemplary embodiment of the present disclosure provides a discrimination method based on supervised learning. In the method, by a data expansion unit, data expansion is performed on unknown data which is an object to be discriminated in such a manner that a plurality of pieces of pseudo unknown data are generated. By a discrimination unit, the unknown data that has been expanded by the data expansion unit is applied to a discriminative model so as to discriminate the expanded plurality of pieces of pseudo unknown data. Then, by the discrimination unit, the discrimination results of the expanded plurality of pieces of pseudo unknown data are integrated to perform class classification such that the unknown data is classified into classes.

In this configuration as well, the unknown data is expanded. A plurality of pieces of pseudo unknown data are generated. The discrimination results of the pieces of pseudo unknown data are integrated. And then, class classification of the unknown data is then performed based on the integrated discrimination results. Therefore, discriminative capability is improved compared to when discrimination is performed on the unknown data itself.

As described above, in the first to third exemplary embodiments, unknown data is expanded. Their discrimination results are then integrated and class classification is performed. Therefore, discriminative capability is improved compared to when discrimination is performed on the unknown data itself.

### BRIEF DESCRIPTION OF THE DRAWINGS

In the accompanying drawings:

FIG. 1 is a block diagram of a configuration of a learning apparatus according to an embodiment of the present invention;

FIG. 2 is a diagram of data distribution (probability density) of a certain class on a certain manifold;

FIG. 3 is a diagram of training data in the data distribution shown in FIG. 2;

FIG. 4 is a diagram of an example of training data for handwritten digits and examples of pseudo data of the training data;

FIG. 5 is a diagram of the distribution of pseudo data;

FIG. 6 is a diagram of definitions of symbols;

FIG. 7 is a diagram of posterior distribution of class obtained as a result of learning pseudo data;

FIG. 8 is a block diagram of a configuration of a discriminator according to the embodiment of the present invention;

FIG. 9 is a diagram of example of unknown data according to the embodiment of the present invention;

FIG. 10 is a diagram of a sample distribution of pseudo unknown data according to the embodiment of the present invention; and

FIG. 11 is a diagram of test results according to the embodiment of the present invention.

### DESCRIPTION OF THE EMBODIMENTS

A learning apparatus and a discriminator according to an embodiment of the present invention will hereinafter be described with reference to the drawings. The embodiment described below gives an example when the present invention is carried out. The embodiment does not limit the present invention to specific configurations described hereafter. When carrying out the present invention, specific configurations based on the implementation may be used accordingly.

An embodiment of the present invention will hereinafter be described, giving as an example a pattern discriminator and a learning apparatus. The pattern discriminator performs class classification of unknown data, such as image data. The learning apparatus is used to learn a discriminative model used by the pattern discriminator. In addition, an instance in which a feed-forward multilayer neural network is used as the discriminative model will be described. Other models, such as a convolutional neural network may also be used as the discriminative model.

### (Learning Apparatus)

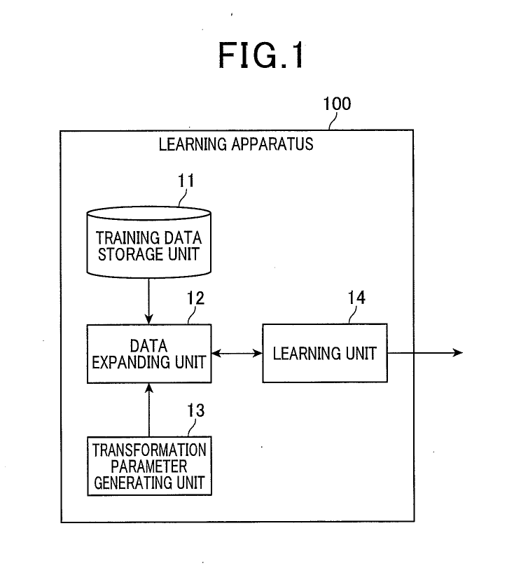

FIG. 1 is a block diagram of a configuration of a learning apparatus according to the embodiment of the present invention. A learning apparatus 100 includes a training data storage unit 11, a data expanding unit 12, a transformation parameter generating unit 13, and a learning unit 14. The learning apparatus 100 is actualized by a computer. The computer includes an auxiliary storage unit, a temporary storage unit, a computation processing unit, and an input/output unit. The training data storage unit 11 is actualized by, for example, the auxiliary storage unit. In addition, the data expanding unit 12, the transformation parameter generating unit 13, and the learning unit 14 are actualized by the computation processing unit running a learning program.

The training data storage unit 11 stored therein training data (hereinafter also referred to as a “data sample”) accompanied by target values. The transformation parameter generating unit 13 generates transformation parameters. The transformation parameters are used by the data expanding unit 12 to expand the training data stored in the training data storage unit 11. The data expanding unit 12 performs data expansion by performing parametric transformation on the training data stored in the training data storage unit 11 using the transformation parameters generated by the transformation parameter generating unit 13.

The learning unit 14 performs a learning process using the training data that has been expanded by the data expanding unit 13. The learning unit 14 thereby generates a discriminative model to be used by the discriminator of the present embodiment. The learning unit 14 decides a weight W of each layer that is a parameter of the multilayer neural network.

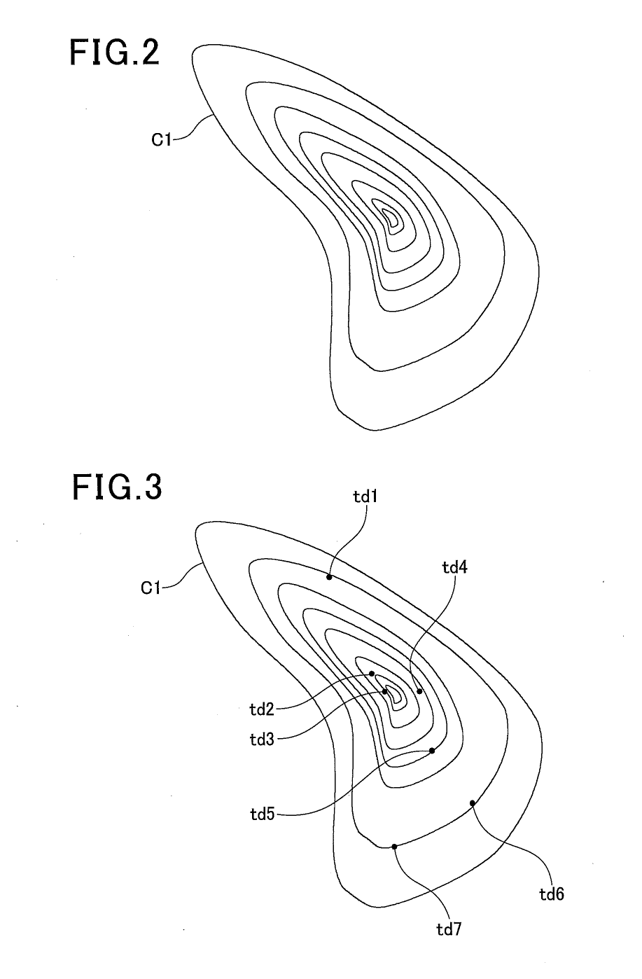

The data expansion performed by the data expanding unit 12 will be described. FIG. 2 is a diagram of data distribution (probability density) of a certain class C1 on a certain manifold. The actual data sample is a random variable based on this data distribution of the class C1 and is generated stochastically.

FIG. 3 is a diagram of the training data in the data distribution shown in FIG. 2. In FIG. 3, training data td1 to td7 are shown in the data distribution of the class C1 shown in FIG. 2. The training data td1 to td7 are stored in the training data storage unit 11. As the number of pieces of training data becomes closer to infinite, the probability density becomes gradually closer to the data distribution of the class C1 shown in FIG. 2. However, in actuality, only a limited number of pieces of training data can be obtained. Therefore, approximation accuracy of the distribution must be rough.

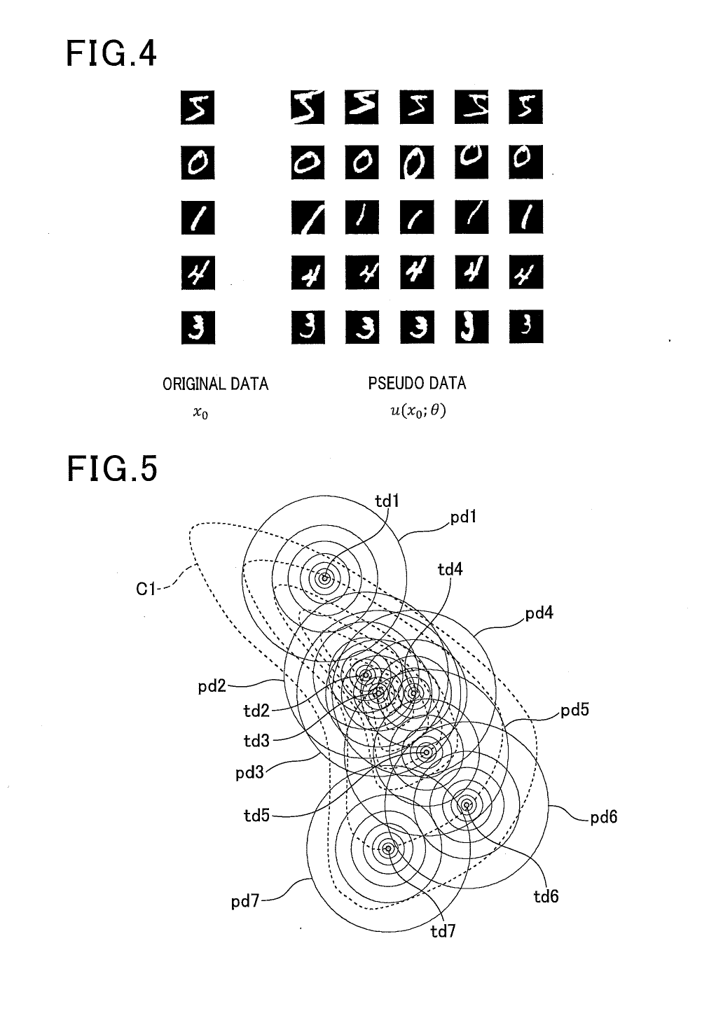

The data expanding unit 12 increases the number of pieces of data by transforming the training data. The transformation is parametric transformation near data points on a manifold of the data. The transformation includes, for example, localized distortions in an image, localized changes in luminance, affine transformations, and noise superposition. FIG. 4 is a diagram of an example of training data (original data) for handwritten digits and new data (pseudo data) obtained by expanding the training data. In FIG. 4, a discriminative model performs recognition of handwritten digits using an image.

FIG. 5 is a diagram of the distribution of pseudo data obtained by expanding the training data. In FIG. 5, the distribution of pseudo data pd1 to pd7 obtained by expanding the training data td1 to td7 is indicated by solid lines. When slight deformation to an extent that class features are not compromised is applied to the training data that has been provided, the pseudo data that is generated as a result is positioned near the original training data.

When one or more transformation parameters (e.g., M transformation parameters θ₁, θ₂, . . . , θ_{M}) are collectively represented by θ and transformation is (x₀;θ), and when a sufficient number of (an infinite number of) pseudo data are generated from a single piece of training data, the pieces of pseudo data have a distribution expressed by the following expression.

$$p ( u ( {x}^{i} ; θ ) ) \{ \begin{matrix}u \text{:} {ℝ}^{D} \to {ℝ}^{D} \\ θ ∼ p ( θ )\end{matrix}$$

Here, D denotes a dimension of data and corresponds to a dimension in a space of the data distribution of the class C1 shown in FIG. 2 (e.g., D=3).

The learning unit 14 learns the expanded training data. As described above, according to the present embodiment, the learning unit 14 learns a feed-forward multilayer neural network as a discriminative model.

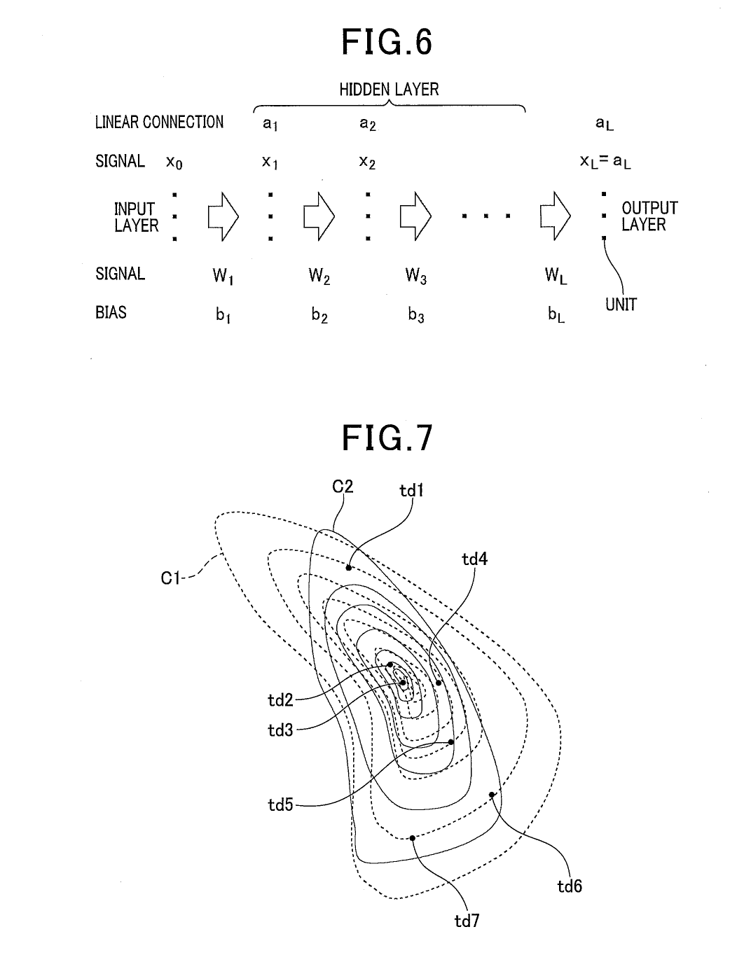

As shown in FIG. 6, the feed-forward multilayer neural network includes a plurality of layers configured by an input layer, an output layer, and at least one hidden layer that lies between the input layer and the output layer. Each of the layers includes one or more units (also called “neurons”, “nodes”, or “processing elements (PEs)”). In each hidden layer, each unit receives data (signals x₀, x₁, x₂, . . . , x_{L}) from each unit of the previous layer (input layer or hidden layer), performs a calculation for linear connection (a₁, a₂, . . . , a_{L}) based on the received data (signals x₀, x₁, x₂, . . . , x_{L}) and elements (W₀, W₁, W₂, . . . , W_{L}) of a weight (W) to produce an output data (output value) (signals x₁, x₂, . . . , x_{L}) and then transfers the output data (signals x₁, x₂, . . . , x_{L}) to each unit of the next layer (hidden layer or output layer).

The learning unit 14 uses an objective function (also called, e.g., cost function) that obtains a lower value as the output value and the target value become closer. The learning unit 1 uses the object function to retrieve parameters of the discriminative model that minimize the objective function. The learning unit 14 decides a discriminative model that has high generalization capability as a result of the retrieval. According to the present embodiment, cross entropy is used as the objective function.

First, the definitions of the symbols are shown in FIG. 6. In FIG. 6, a₁ (1=1, 2, . . . , L) denotes each linear connection between the adjacent layers of the feed-forward multilayer neural network, and x₁ (1=1, 2, . . . , L) denotes data (signals) transmitted between the adjacent layers, where a₁ and x₁ are defined as follows.

$${a}_{l} = {\overline{W}}_{l} {\overline{x}}_{l - 1} \{ \begin{matrix}{\overline{W}}_{l} = [ {W}_{l} \vert {b}_{l} ] \\ {\overline{x}}_{l} = {[ {x}_{l}^{T} \vert 1 ]}^{T}\end{matrix} \\ {x}_{l} = {f}_{l} ( {a}_{l} )$$

Here, f₁ is a differentiable (subdifferentiable) monotonically non-decreasing or non-increasing function.

In addition, the number of dimensions of the output is the number of classes. The target values are set such that one of the units of the output layer has the value 1, and the remaining at least one unit have the value 0. In a two-class classification, the output may be one dimensional. In this case, the target value is 0 or 1.

First, a learning process when data expansion is not performed will be described below. A learning process when data expansion is perfofined according to the present embodiment will subsequently be described in comparison with the learning process when data expansion is not performed.

The objective function when data expansion is not performed is expressed by the following expressions (1) and (1′).

$$\begin{matrix}{G}_{train} ( W ) = {\sum }_{i ∈ train} {G}_{i} ( W ) \to min & ( 1 ) \\ {G}_{i} ( W ) = {\sum }_{c ∈ C} - {t}_{c}^{i} ln {y}_{c} ( {x}_{0}^{i} ; W ) \\ s . t . \{ \begin{matrix}{y}_{c} = {softmax ( {a}_{L} )}_{c} \to {\sum }_{c} {y}_{c} = 1 , 0 < {y}_{c} < 1 \\ {\sum }_{c} {t}_{c} = 1 , {t}_{c} ∈ \{ 0 , 1 \} ( Target value of training data ) \\ W = \{ {\overline{W}}_{1} , {\overline{W}}_{2} , … {\overline{W}}_{L} \}\end{matrix} & ( {1}^{′} )\end{matrix}$$

Here, Gᵢ (W) denotes the objective function, i denotes the index of the training data, and C denotes the class level.

In this way, a softmax function is applied to the output of the neural network, and then, the vector is normalized and the value is converted to a positive value. Cross entropy defined by the expression (1′) is applied to the vector. As a result, poor classification of a certain training sample is quantified. In the instance of a one-dimensional output y(x₀ⁱ;W), the expressions (1) and (1′) can be applied by substitution of variables so that y₁(x₀ⁱ;W)=y(x₀ⁱ;W), y₂(x₀ⁱ;W)=1−y(x₀ⁱ;W), t1=1, and t2=1−t.

The following gradient of the objective function Gᵢ (W) is calculated.

$$\frac{\partial {G}_{i}}{\partial {\overline{W}}_{l}}$$

A gradient obtained by the sum of a plurality of data samples is used to update the elements W₀, W₁, W₂, . . . , W_{L} of the weight W as in expression (2) below through stochastic gradient descent (SGD).

$${\overline{W}}_{l} ← {\overline{W}}_{l} - ε {\sum }_{i ∈ RPE} \frac{\partial {G}_{i}}{\partial {\overline{W}}_{l}} \qquad ( 2 )$$

The update is repeatedly performed until the elements W₀, W₁, W₂, . . . , W_{L} of the weight W (the weight of each layer) are converged. Here, RPE in expression (2) is an acronym of randomly picked example, and refers to randomly selecting a data sample for each repetition.

Next, an instance according to the present embodiment in which data expansion is performed will be described. The objective function Gᵢ (W) according to the present embodiment is as expressed by the following expressions (3) and (3′).

$$\begin{matrix}{G}_{train} ( W ) = {\sum }_{i ∈ train} {G}_{i} ( W ) \to min & ( 3 ) \\ {G}_{i} ( W ) = {\sum }_{c ∈ C} {E}_{θ} [ - {t}_{c}^{i} ln {y}_{c} ( u ( {x}_{0}^{i} ; θ ) ; W ) ] \\ {E}_{θ} [ … ] ≃ \frac{1}{M} {\sum }_{θ = {θ}_{1} , {θ}_{2} , … , {θ}_{M}} … , {θ}_{j} ∼ p ( {θ}_{j} ) \\ s . t . \{ \begin{matrix}{y}_{c} = {softmax ( {a}_{L} )}_{c} \to {\sum }_{c} {y}_{c} = 1 , 0 < {y}_{c} < 1 \\ {\sum }_{c} {t}_{c} = 1 , {t}_{c} ∈ \{ 0 , 1 \} ( Target value of training data ) \\ W = \{ {\overline{W}}_{1} , {\overline{W}}_{2} , … {\overline{W}}_{L} \}\end{matrix} & ( {3}^{′} )\end{matrix}$$

Unlike in expression (1′), the training data itself is not inputted into the learning unit 14 in expression (3′). Rather, the data expanding unit 12 generates pseudo data and inputs the pseudo data into the learning unit 14. The pseudo data is artificial data derived by transformation from the training data. In addition, unlike in expression (1′), an expected value of cross entropy for the transformation parameter is obtained. The learning unit 14 uses stochastic gradient descent as the method for optimizing the objective function.

A specific procedure is as follows. The data expanding unit 12 selects a single piece of training data stored in the training data storage unit 11. In addition, the data expanding unit 12 samples a plurality of transformation parameters from the transformation parameter generating unit 14 using random numbers based on an appropriate probability distribution. The data expanding unit 12 performs transformation of the training data using the parameters. The data expanding unit 12 thereby expands the single piece of training data into a plurality of pieces of data.

The learning unit 14 uses the plurality of pieces of pseudo data to calculate the following gradient.

$$\frac{\partial {G}_{i}}{\partial {\overline{W}}_{l}}$$

The learning unit 14 uses the gradient that is the sum of the plurality of data samples and updates the elements W₀, W₁, W₂, . . . , W_{L}, of weight W as in expression (4) below through stochastic gradient descent.

$${\overline{W}}_{l} ← {\overline{W}}_{l} - ε {\sum }_{i ∈ RPERD} \frac{\partial {G}_{i}}{\partial {\overline{W}}_{l}} \qquad ( 4 )$$

The update is repeatedly performed until the elements W₀, W₁, W₂, . . . , W_{L}, of weight W (the weight of each layer) are converged. Here, RPERD in expression (4) is an acronym of randomly picked example with random distortion, and refers to selecting a data sample from data samples that have been deformed using random numbers.

Ordinarily, an error back-propagation method is used to update the parameter of the weight W of the multilayer neural network. The error back-propagation method applies a gradient method in sequence from the output layer side to the input layer side via the at least one hidden layer, as shown in FIG. 6. The error back-propagation method is also a type of gradient method. Therefore, stochastic gradient descent can be applied. C. M. Bishop, “Pattern Recognition and Machine Learning”, Springer Japan describes the error back-propagation method in detail.

FIG. 7 is a diagram of a posterior distribution of class obtained as a result of learning of the pseudo data generated by the data expanding unit 12, as described above. In FIG. 7, the posterior distribution of class C2 is indicated by the solid lines. A discriminator performs discrimination using the posterior distribution of class C2 as a discriminative model. As a result of the data expansion, comprehensiveness in relation to the original distribution of class C1 shown in FIG. 2 can be improved.

### (Discriminator)

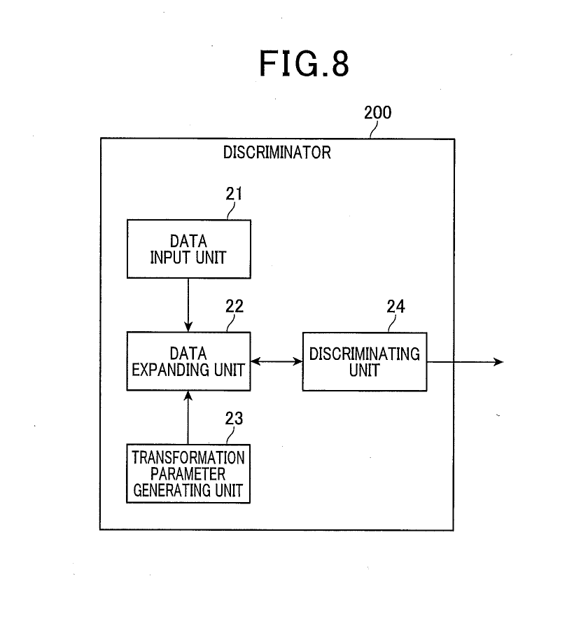

Next, a discriminator according to the present embodiment will be described. FIG. 8 is a block diagram of a configuration of the discriminator according to the present embodiment.

A discriminator 200 includes a data input unit 21, a data expanding unit 22, a transformation parameter generating unit 23, and a discriminating unit 24. The discriminator 200 is actualized by a computer. The computer includes an auxiliary storage unit, a temporary storage unit, a computation processing unit, an input/output unit, and the like. The data input unit 21 is actualized by, for example, the input/output unit. In addition, the data expanding unit 22, the transformation parameter generating unit 23, and the discriminating unit 24 are actualized by the computation processing unit running a discrimination program according to the embodiment of the present invention.

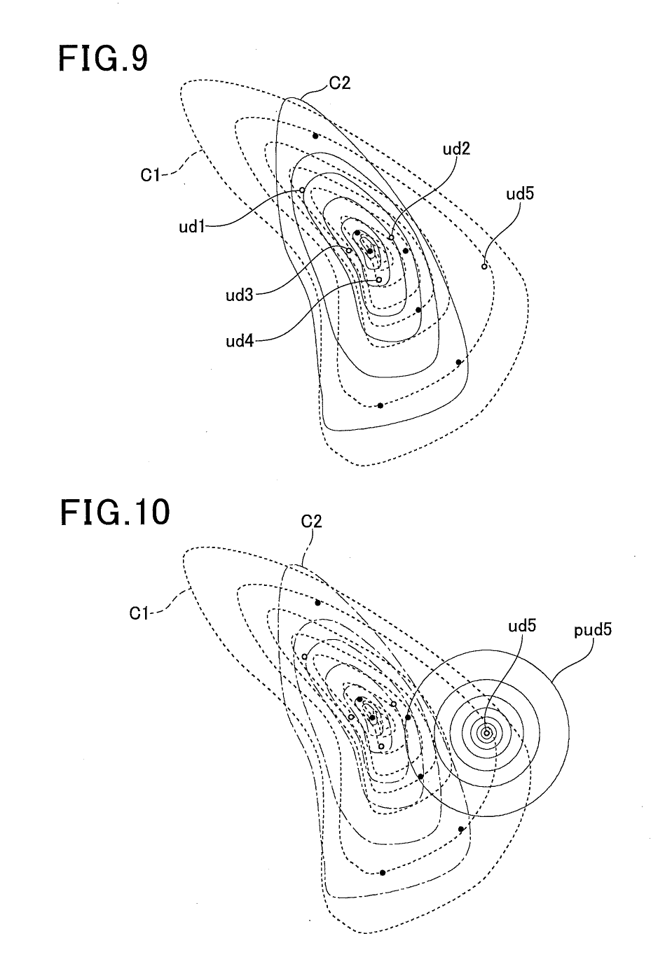

Data that is unknown and is not used for learning is inputted into the data input unit 21. FIG. 9 is a diagram of an example of unknown data ud1 to ud5. When the unknown data ud1 to ud5 shown in FIG. 9 is inputted, a correct answer can often be made as a result of improved comprehensiveness resulting from data expansion. However, an erroneous answer may also be made due to limitations in the approximation accuracy of the original distribution, as in the unknown data ud5.

Therefore, according to the present embodiment, the discriminator 200 performs data expansion even for discrimination, using a method similar to that for learning. The discriminator 200 then appropriately integrates the discrimination results from the expanded data. In this way, as a result of the data being expanded using random numbers during discrimination as well, the possibility of the distribution overlapping the posterior distribution of class increases. Therefore, the possibility of a correct answer being made when a correct answer could not be made in the past increases. A reason therefore will be described in detail below.

When data expansion is not performed, the most appropriate class classification method when a certain piece of data is inputted is to select a class c that satisfies the following expression (5).

y_{c}(x₀;W)≧y_{c′≠c}(x₀;W) (5)

This decision rule minimizes the objective function (1′) for when data expansion is not performed, and is theoretically optimal.

Conventionally, the decision rules for when data expansion is not performed have been used even when data expansion is performed. In other words, even when learning is performed using the expression (3′) during learning, discrimination (class classification) using the decision rule in expression (5), which is theoretically optimal when data expansion is not performed, is performed for discrimination. However, the theoretically optimal decision rule differs between when data expansion is performed and when data expansion is not performed. In other words, the above-described decision rule in expression (5) is a minimization of the objective function Gᵢ (W) in expression (1′) for when data expansion is not performed. However, the decision rule is not a minimization of the objective function Gᵢ (W) in expression (3′) for when data expansion is performed.

When data expansion is performed, the optimal class classification method is to select a class c that satisfies the following expression (6).

E_{θ}[ln y_{c}(u(x₀;θ);W)]≧E_{θ}[1n y_{c′≠c}(u(x₀;θ);W)] (6)

This decision rule minimizes the object function Gᵢ (W) in expression (3′), and is theoretically optimal.

As described above, in the conventional method, regardless of the objective function for data expansion being minimized during learning, the decision rule in expression (5) is applied. Therefore, theoretically optimal class classification cannot be performed. Conversely, the discriminator 200 according to the present embodiment performs discrimination by obtaining the expected value of a logarithm of output for the transformation parameters even during discrimination.

Specifically, the discriminator 200 performs processes at the following steps, i.e., a data expanding step and a discriminating step according to a discrimination method of the present embodiment.

### (Data Expanding Step)

First, the discriminator 200 performs a process at the data expanding step. In the process, the data expanding unit 22 transforms unknown data inputted into the data input unit 21 using the transformation parameters generated by the transformation parameter generating unit 23. The data expanding unit 22 thereby generates a plurality of pieces of pseudo unknown data. The transformation parameters used by the data expanding unit 22 are stochastically generated from a distribution p (θⱼ) that has been used for learning to generate the discriminative mode. FIG. 10 is a diagram of a sample distribution of the pseudo unknown data pud5 generated from the unknown data qd5 shown in FIG. 9. In FIG. 10, the sample distribution of the pseudo unknown data pud5 generated from the unknown data qd5 is indicated by solid lines.

### (Discriminating Step)

Subsequently, the discriminator 200 performs a process at the data expanding step. In the process, the discriminating unit 24 performs the gradient calculation in expression (6). The discriminating unit 24 then selects a class level at which the expected value of the logarithm of output for the transformation parameters is the highest. In this way, through use of the optimal decision rule for data expansion, discriminative capability higher than that in the past can be achieved even when the amount of collected data is the same and data expansion is performed in the same manner.

According to the present embodiment, cross entropy is used as the objective function. However, the objective function is not limited to cross entropy. A decision rule when the objective function is the total sum of the square of error will be described below. The objective function Gᵢ (W) when data expansion is not performed is expressed by the following expressions (7) and (7′).

$$\begin{matrix}{G}_{train} ( W ) = {\sum }_{i ∈ train} {G}_{i} ( W ) \to min & ( 7 ) \\ {G}_{i} ( W ) = {\sum }_{c ∈ C} {( {y}_{c} ( {x}_{0}^{i} ; W ) - {t}_{c}^{i} )}^{2} \\ s . t . \{ \begin{matrix}{y}_{c} = {softmax ( {a}_{L} )}_{c} \to {\sum }_{c} {y}_{c} = 1 , 0 < {y}_{c} < 1 \\ {\sum }_{c} {t}_{c} = 1 , {t}_{c} ∈ \{ 0 , 1 \} ( Target value of training data ) \\ W = \{ {\overline{W}}_{1} , {\overline{W}}_{2} , … {\overline{W}}_{L} \}\end{matrix} & ( {7}^{′} )\end{matrix}$$

The following gradient of the objective function Gᵢ (W) is calculated.

$$\frac{\partial {G}_{i}}{\partial {\overline{W}}_{l}}$$

A gradient obtained by the sum of a plurality of data samples is used to update the elements of weight W as in expression (8) below through stochastic gradient descent (SGD). The update is repeatedly performed until the elements of weight W are converged.

$${\overline{W}}_{l} ← {\overline{W}}_{l} - ε {\sum }_{i ∈ RPE} \frac{\partial {G}_{i}}{\partial {\overline{W}}_{l}} \qquad ( 8 )$$

Next, an instance according to the present embodiment in which data expansion is performed in the above-described example will be described. The objective function Gᵢ(W) according to the present embodiment is as expressed by the following expressions (9) and (9′).

$$\begin{matrix}{G}_{train} ( W ) = {\sum }_{i ∈ train} {G}_{i} ( W ) \to min & ( 9 ) \\ {G}_{i} ( W ) = {\sum }_{c ∈ C} {E}_{θ} [ {( {y}_{c} ( u ( {x}_{0}^{i} ; θ ) ; W ) - {t}_{c}^{i} )}^{2} ] \\ {E}_{θ} [ … ] ≃ \frac{1}{M} {\sum }_{θ = {θ}_{1} , {θ}_{2} , … , {θ}_{M}} … , {θ}_{j} ∼ p ( {θ}_{j} ) \\ s . t . \{ \begin{matrix}{y}_{c} = {softmax ( {a}_{L} )}_{c} \to {\sum }_{c} {y}_{c} = 1 , 0 < {y}_{c} < 1 \\ {\sum }_{c} {t}_{c} = 1 , {t}_{c} ∈ \{ 0 , 1 \} ( Target value of training data ) \\ W = \{ {\overline{W}}_{1} , {\overline{W}}_{2} , … {\overline{W}}_{L} \}\end{matrix} & ( {9}^{′} )\end{matrix}$$

In this way, unlike in expression (7′), the expected value of the total sum of the square of error for the transformation parameter is obtained in expression (9′).

Conventionally, the following expression (10) has been used as the decision rule.

y_{c}(x₀;W)≧y_{c′≠c}(x₀;W) (10)

This decision rule is a minimization of the objective function Gᵢ (W) in expression (7′) for when data expansion is not performed. However, the decision rule is not a minimization of the objective function Gᵢ (W) in expression (9′) for when data expansion is performed. Therefore, when data expansion is performed, a decision rule that minimizes the expected value of the total sum of the square of error for the transformation parameter is used as in the following expression (11).

E_{θ}[y_{c}(u(x₀;θ);W)]E_{θ}[y_{c′≠c}(u(x₀;θ);W)] (11)

When data expansion is performed, discriminative capability that is higher than that in the past can be achieved in a manner similar to the above-described embodiment through use of the decision rule in expression (11).

As described above, in the discriminator 200 according to the present embodiment, the data expanding unit 22 performs data expansion on unknown data using a method similar to that for data expansion for learning. The data expanding unit 22 thereby generates pseudo unknown data. The discriminating unit 24 then performs class classification based on the expected values of the pseudo unknown data.

In other words, the discriminator 200 does not perform class classification of the unknown data itself. Rather, the discriminator performs class classification by expanding the unknown data and integrating the results of class classification of the expanded unknown data. In other words, the discriminator 200 performs class classification based on a decision rule that is minimization of an objective function used for learning.

As a result, when a discriminative model is generated through learning of provided training data after data expansion, discriminative capability can be actualized that is higher than that by a conventional method when the amount of collected training data is the same and the training data is expanded in the same manner.

In related art, the same decision rule related to class classification of unknown input data that is classified into classes is used both when data expansion is performed and when data expansion is not performed. As described above, in the present embodiment, based on the understanding that theoretically optimal decision rules differ between when data expansion is performed and when data expansion is not performed, improvements in data expansion have been made in the discriminator.

In the present embodiment, the decision rules related to class classification of unknown input data that is classified into classes are improved as described above. Thus, a discriminative capability of the discriminator can be improved when discrimination of the unknown input data is performed based on learning process using data expansion of the training data.

### Test Example

A test conducted using the learning apparatus and the discriminator according to the present embodiment will be described below. The following conditions were set for the test. A handwritten digit data set (refer to MNIST, http://yam.lecun.com/exdb/mnist, and FIG. 4) was prepared as a data set. Six thousand sets among the training data sets (60,000 sets) in the MNIST database were used as the training data. A thousand sets among the test data sets (10,000 sets) in the MNIST database were used as the test data. A feed-forward, fully connected, six-layer neural network was used as the discriminative model. Discrimination error rate was evaluated as the evaluation criteria.

As the learning condition of the learning apparatus, the same data expansion was applied for both when discrimination is performed by the conventional method and when discrimination according to the embodiment of the present invention is performed.

In addition, a derivative was calculated only once from a generated sample. No derivative was calculated from the original sample. As the discrimination condition of the discriminator, in the conventional method, only the original sample was discriminated. In the discriminator according to the present embodiment, the expected values were evaluated from a plurality of generated samples. The original sample itself was not used for the expected values in the discriminator according to the present embodiment.

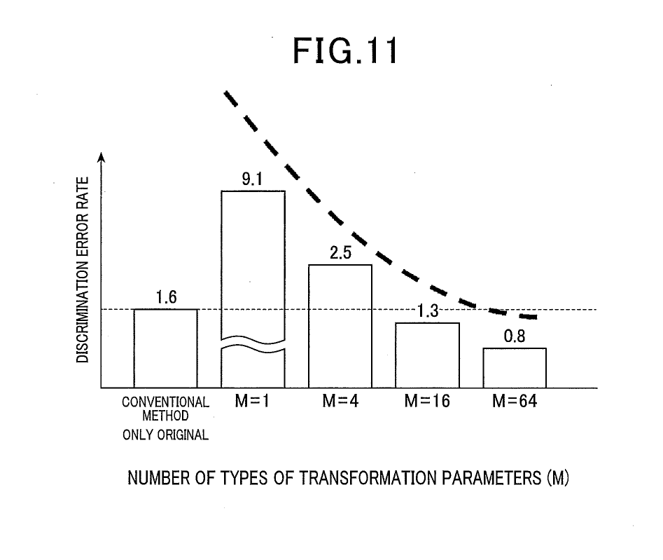

The test results are shown in FIG. 11. In FIG. 11, the horizontal axis indicates the number M of types of transformation parameters. The vertical axis indicates the discrimination error rate. The discrimination error rate when the conventional method was used is also indicated. As described above, the following expression is established regarding the number M of types of transformation parameters.

$${E}_{θ} [ ln {y}_{c} ( u ( {x}_{0} ; θ ) ; W ) ] ≃ \frac{1}{M} {\sum }_{θ = {θ}_{1}}^{{θ}_{M}} ln {y}_{c} ( u ( {x}_{0} ; θ ) ; W )$$

From the results in FIG. 11, it is clear that, when the number of types of transformation parameters is M=16 or more, the discrimination error rate is lower than that when discrimination of only the original sample is performed in the conventional method. This shows that the expected value computation for discrimination according to the present embodiment is effective.

In the present embodiment, unknown data is expanded. The discrimination results of the expanded unknown data are integrated and class classification is performed. Therefore, the present invention is useful as, for example, a discrimination apparatus that uses a discriminative model generated through a learning process of training data that has been expanded. The discrimination apparatus achieves an effect in which discriminative capability is improved compared to when discrimination is performed on the unknown data itself.

What is claimed is:

1. A discriminator based on supervised learning, the discriminator comprising:
a data expanding unit that performs data expansion on unknown data that is an object to be discriminated, in such a manner that a plurality of pieces of pseudo known data are generated; and
a discriminating unit that applies the plurality of pieces of unknown pseudo data that has been expanded by the data expansion unit to a predetermined discriminative model so as to discriminate the plurality of pieces of pseudo unknown data, and integrates discriminative results of the plurality of pieces of pseudo unknown data to perform class classification such that the unknown data is classified into classes.

2. The discriminator according to claim 1, wherein:
the data expanding unit performs the data expansion on the unknown data using the same method as data expansion performed on training data when the discriminative model is generated.

3. The discriminator according to claim 2, wherein:
the discriminating unit performs the class classification based on expected values derived by applying the plurality of pieces of unknown pseudo data to the discriminative model.

4. The discriminator according to claim 3, wherein:
the discriminating unit performs the class classification without applying the unknown data to the discriminative model.

5. The discriminator according to claim 4, wherein:
the data expanding unit performs the data expansion on the unknown data using random numbers.

6. The discriminator according to claim 1, wherein:
the discriminating unit performs the class classification based on expected values derived by applying the plurality of pieces of unknown pseudo data to the discriminative model.

7. The discriminator according to claim 1, wherein:
the discriminating unit performs the class classification without applying the unknown data to the discriminative model.

8. The discriminator according to claim 1, wherein:
the data expanding unit performs the data expansion on the unknown data using random numbers.

9. A computer-readable storage medium storing a discrimination program for enabling a computer to function as a discriminator based on supervised learning, the discriminator comprising:
a data expanding unit that performs data expansion on unknown data that is an object to be discriminated in such a manner that a plurality of pieces of pseudo known data are generated; and
a discriminating unit that applies the plurality of pieces of unknown pseudo data that has been expanded by the data expansion unit to a predetermined discriminative model so as to discriminate the plurality of pieces of pseudo unknown data, and integrates discriminative results of the plurality of pieces of pseudo unknown data to perform class classification such that the unknown data is classified into classes.

10. A discrimination method based on supervised learning, the discrimination method comprising:
performing, by a data expansion unit, data expansion on unknown data that is an object to be discriminated in such a manner that a plurality of pieces of pseudo known data are generated;
applying, by a discriminating unit, the plurality of pieces of unknown data that has been expanded by the data expansion unit to a predetermined discriminative model so as to discriminate the plurality of pieces of pseudo unknown data; and
integrating, by the discriminating unit, discriminative results of the plurality of pieces of pseudo unknown to perform class classification such that the unknown data is classified into classes.
